(19) United States
(12) Patent Application Publication
(10) Pub. No.: US 2008/0302252 A1
(43) Pub. Date: Dec. 11, 2008

(54) Portable Brewing Device and Method of Making and Operating

(75) Inventors: Stephen James O'Brien, San Jose, CA (US); Carmel Ish-Shalom, Alameda, CA (US); David Richard Stevens, San Jose, CA (US)

Correspondence Address: Stevens Law Group, 1754 Technology Drive, Suite #226, San Jose, CA, 95110, US

(73) Assignee: Espressi Corporation, San Jose, CA (US)

(21) Appl. No.: 12/137,533

(22) Filed: Jun. 11, 2008

Related U.S. Application Data
(60) Provisional application No. 60/934,294, filed on Jun. 11, 2007.

(51) Int. Cl. A47J 31/32

(52) U.S. Cl. 99/302 R

(57) ABSTRACT

A portable brewing device is provided for brewing a hot beverage such as espresso that includes a compressed gas container communicating with a pressure regulator that is configured to control the pressure of gas released from the compressed gas container. A release switch is configured to communicate with pressure regulator and configured to release pressure controlled gas when actuated by a user. A water vessel is configured to receive the pressure controlled gas when the switch is actuated by a user. A mixing vessel can hold a brew substance and is configured to communicate with the water vessel and also configured to receive water from the water vessel to pass through the brew substance when pressure is released from the gas container through the pressure regulator. An outlet is configured to release a brewed product produced from water flowing through the brew substance contained in the mixing vessel when brewing.

### BACKGROUND

The invention relates to a convenient device for making or brewing a hot beverage, such as an espresso typically used in a wide range of coffee-based drinks.

Many coffee makers and brewing devices exist in the art, and such devices have been utilized by coffee shops, cafes, and other establishments for a long time. In particular, devices for brewing espresso enjoy a special distinction, where espresso lovers are able to enjoy a special coffee beverage resulting in a flavorful product with a foamy crema top finish from a unique brewing process.

A good espresso can be sweet without requiring sugar, drank without scalding, and leaves a rich taste that lasts for hours. An espresso that can achieve all of these qualities is made by quickly and thoroughly extracting many of the flavors from the ground coffee through a high operating pressure that does not allow time for the development of burnt or bitter overtones. This causes the extraction of essential oils from the ground coffee bean, leading to the crema's intense flavors, aroma and color. These same qualities are also imparted to the brewed liquid that forms the majority of the resultant coffee. The release of carbon dioxide trapped within the coffee grounds produces a finely-frothed crema that coats the palette and continues to impart flavor long after the coffee itself has been consumed.

The science and physical requirements for producing a good espresso and its accompanying crema are well known to those versed in the art. They include high pressures of approximately 130 psi-145 psi (9-10 bars), although this may vary to as high as 240 psi (19 bars) on machines such as those marketed under the Nespresso™ brand for example. Water temperature typically should be 197° F.-205° F. (92-96° C.), and the coffee beans should be as freshly roasted and ground as closely in time to the brewing time as possible. The espresso extraction by running the hot water through the coffee grounds should take no longer than 25-30 seconds. Failure to meet any of these requirements can result in coffee that may be lacking in taste, too bitter to the taste, or that may be lacking sufficient crema in part or in whole. The water temperature can be controlled. Since the hot water typically prepared is so close to the natural boiling point of water at sea level, it can be used to deliver a consistent pressure required to produce a good espresso. And, though wide varieties of espresso machine designs have been proposed or produced, there still exists a need for an effective portable espresso maker.

The first espresso machine built relied on pressure to create at the base of a tall column of hot water. Steam pressure was used to force water up into the raised piping system, where it would then force its way down through the espresso grounds and into a cup. Due to its size and elaborate piping this, was an impractical design and expensive.

In order to easily control the pressure produced within an espresso machine, to provide a convenient supply of water at the correct temperature, and to provide the entire package in a more practical size, current espresso makers are almost always electrically powered. The design, although with many variations, generally includes a boiler that can hold sufficient water to make several cups of espresso, a water heater unit, a water pump, and a “portafilter group” to hold the coffee grounds. The design may also contain a steaming wand for heating and frothing milk, and in more expensive machines, a separate kettle dedicated to producing the steam for the steaming wand.

Electricity is used to heat an internal water boiler, an optional secondary steam boiler, and a high pressure water pump. The water pump forces the water from the boiler through fine coffee grounds either compressed (“tamped”) into a portafilter basket (the removable container that holds the coffee grounds as is typically attached to the machine using a “twisting” action), or contained within a “pod” that sits within the portafilter or, in the case of the Nespresso machines, within its own disposable aluminum pod. In smaller machines the electrical pump will cause a significant amount of noise. This noise is hidden in larger machines, or masked by the background noise of a busy restaurant or café.

There are also many devices that claim an “Espresso” capability that by design are unable to achieve the required operating pressure to extract sufficient flavor compounds and essential oils from the coffee beans.

Because water boilers and high-pressure water pumps and their necessary pipes, pressure bypass valves and other engineering requirements tend to be large and heavy, most espresso machines tend to be quite bulky and heavy. They would not, for example, easily fit inside one's backpack, and would probably be too heavy to easily carry if they did.

However, the market for portable espresso makers does exist and to date has been served by several classes of devices, including steam powered Moka pots, water expansion devices, manual water-pumped devices, manual air-pumped devices, and other devices.

Moka pots rely on a low steam pressure to force heated water through the coffee grounds. The result is often called espresso but fails to produce a real crema due to the low operating pressure. It can be more accurately considered a strong coffee. The Moka pot consists of three sealed chambers arranged vertically. The middle chamber is connected to each other chamber by a narrow pipe. The water is heated in the bottom chamber where it also develops a head of steam. This pushes the water into the middle chamber where the coffee grounds are stored. It passes through the coffee grounds and is forced by the continual release of steam from the lowest chamber into the upper chamber where it is stored awaiting decantment by the operator. The original Moka pot required a stove to provide its heat, however a number of variations on the moka pot have also been created including those with their own heating element, and those that lack the top chamber and instead extend the upper pipe into a an upside-down ‘U’ shape so that it will decant directly into a receptacle such as an espresso cup where the beverage will await consumption. (This last device is patented.) All of the devices in this class must be operated on top of a heat source either external or built in. Their steam-based design lacks the required pressure for crema production.

A water expansion device (also patented) is similar in principle to the steam-powered Moka pot with the exception that it uses the property of water to expand when being heated to provide the operating pressure. These devices also suffer from a lack of continuous high operating pressure.

Manual water-pumped machines use a single-stroke piston-pump attached to a large handle. The user pulls down on the handle in a steady action to force the piston into a chamber holding the hot water, and therefore to push that water through the grounds. These machines tend to be large and heavy, and require significant skill to operate. Smaller alternatives have been developed that are unable to reach a suitable operating pressure.

The newest category of devices is the manual air-pumped machine. There are two types of such devices which we shall call stored-pressure and continuous-pressure devices. A stored-pressure device such as the Handpresso uses a pump similar to that used to inflate bicycle tyres to compress air into a small storage cylinder. Once the cylinder has reached a sufficient pressure that stored gas is vented into a chamber containing hot water. The hot water is then expelled under pressure through a second chamber containing coffee grounds and from there into the beverage container. Producing a pressurized gas charge sufficient to produce an espresso with the Handpresso requires approximately 40 strokes of the pump handle. Despite this strenuous effort the espresso produced suffers because the device rapidly reduces in operating pressure. Optimal espresso production requires a continuous high pressure throughout the entire 25-30 second extraction process.

The continuous-presure device such as the Preva attaches the manually driven piston air-pump directly to the chamber containing the hot water. As soon as the user starts operating the device it commences releasing pressure through the bottom of the chamber, thus forcing the water through the coffee grounds. Only a small amount of pressure is built-up by the Preva and the resultant beverage lacks most of the qualities of a good espresso. As the operator continues to pump after all the water has been expelled then the air will mix with the water stored in the coffee grounds and come out as a slight froth on top of the coffee. This froth is not the same as crema.

So far, the correct operating pressure for good quality espresso production has only been achieved with large hand-pumped or water pump-driven solutions. The size of espresso machines, their electrical requirement, and the use of an internal water heater, prevents the design of a portable unit based on the same methods. In order to produce a portable espresso machine that has no requirement for external power it is necessary to develop a new design.

Chart 1 below illustrates the difference in the operating pressure profiles throughout the espresso extraction process for different classes of machine against the ideal pressure profile.

The Handpresso device achieves its initial pressure because of the small size of the pressure vessel and the maximum pressure of about 130 PSI. The pressure reduces rapidly as the compressed air is released into the water vessel.

The Preva device never achieves the pressure needed to extract an espresso because the compressed air that is pumped into the water vessel pushes the water into the grinds as soon as any positive pressure is achieved. The pulsating pressure profile is due to the continuous pumping action required by the user until the coffee has been dispensed.

The Espresso curve shows the correct pressure profile required to achieve a high quality espresso taste and crema. While the specific pressure for the Espresso profile may vary +/−20 psi, this is the typical profile achieved within professional and high-end consumer espresso machines.

Therefore, there exists a need in the art for an improved espresso machine that is portable and easy to use and that also brews a quality espresso beverage. As will be seen, the invention provides such a device and related method in an elegant manner, and also provides alternative uses for other beverages.

### BRIEF DESCRIPTION OF THE DRAWINGS

FIGS. 1, 2A, 2B, and Subsequent FIGS. 1-4 are diagrammatic views of a portable brewing device configured according to the invention.

FIGS. 2C and 2D are detailed views of the operation switch configured according to the invention.

FIG. 2E is a flow chart illustrating the operation of a device configured according to the invention.

FIGS. 2, 3, and 4A illustrate different configurations of lid and sealing configurations for sealing a chamber or container for holding grounds and also a chamber or container for holding water.

FIGS. 5 and 6 illustrate commercial embodiments of devices configured according to the invention.

### DETAILED DESCRIPTION

In the following detailed description of the invention, numerous specific details are set forth in order to provide a thorough understanding of the invention. However, it will be obvious to one skilled in the art that the invention may be practiced without these specific details. In other instances well known methods, procedures, components, and elements have not been described in detail so as not to unnecessarily obscure aspects of the invention.

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

The invention has been developed in response to the present state of the art, and in particular, in response to the problems and needs in the art that have not yet been fully solved by currently available espresso and other beverage brewing methods and architectures. Accordingly, the invention has been developed to provide novel apparatus and methods for portably brewing expresso. The features and advantages of the invention will become more fully apparent from the following description and appended claims and their equivalents, and also any subsequent claims or amendments presented, or may be learned by practice of the invention as set forth hereinafter.

While the following description provides specific details relevant to the production of an espresso extract from ground coffee with hot water, the invention may be used to provide an extraction from any suitable base product using any suitable liquid, including using flavored liquids, ground tea, herbs and spices, and any other combination of extraction liquid and extraction compound that is required.

The invention provides a portable beverage maker, illustrated and described as a portable espresso maker that derives the operating pressure for extracting an espresso beverage from ground coffee (or “brew compound”) where the pressure required for such extraction is stored in a compressed gas container, controlled with a pressure regulator and supplied to a water vessel that contains the hot water required to make the beverage. Other beverages may be brewed from this method, and a portable device configured according to the invention can have many diverse applications, such as having a general purpose hot beverage device. Or, it could be a specialized device that brews only espresso, or that only brews tea, etc. Those skilled in the art will understand the adaptability of the invention, and the ability to make, use or sell useful products that include elements of the invention. The invention, however, is not limited to any particular application, and extends to all equivalents embodied within the scope of the appended claims.

Generally, the invention provides devices and methods in various scopes, as illustrated and described herein.

In one embodiment, a portable brewing device for brewing a hot beverage such as espresso is provided that includes a compressed gas container communicating with a pressure regulator that is configured to control the pressure of gas released from the compressed gas container. A release switch is configured to communicate with pressure regulator and configured to release pressure controlled gas when actuated by a user. A water vessel is configured to receive the pressure controlled gas when the switch is actuated by a user. A mixing vessel can hold a brew substance and is configured to communicate with the water vessel and also configured to receive water from the water vessel to pass through the brew substance when pressure is released from the gas container through the pressure regulator. An outlet is configured to release a brewed product produced from water flowing through the brew substance contained in the mixing vessel when brewing.

In one embodiment, the device includes a piercing member configured to puncture the compressed gas container to release the compressed gas under the control of the pressure regulator. A release valve may be configured to puncture the compressed gas container to release the compressed gas under the control of the pressure regulator.

The compressed gas container may be a pre-compressed and sealed container, and wherein the release valve is a piercing member configured to puncture the container to release compressed gas.

The pressure regulator may be a manual control configured to adjust pressure of gas released from the compressed gas container.

The device may further include a release valve configured to expose the compressed gas to the pressure regulator to enable controlled release. The valve may not be located between the compressed gas source and the regulator, but may alternatively be located between the regulator and the water vessel.

The pressure regulator may be configured to control pressure within water vessel. The pressure regulator may alternatively be configured to control pressure released from the compressed gas container. The pressure regulator may be configured to increase and decrease pressure within the water vessel to cause the controlled transfer of water from the water vessel into the grounds vessel. The pressure regulator may be configured to control pressure within water vessel in a manner to transfer water from the water vessel into the grounds vessel in a controlled manner.

The device may include a water distributor configured to distribute the water transferred into the grounds vessel in a controlled manner, so that water is evenly distributed over the grounds, optimizing the brewing process. The water distributor may be configured to distribute the water transferred into the grounds vessel in a controlled manner to evenly distribute the transferred water over a surface of grounds contained in the grounds vessel.

A safety release valve may be configured to release pressurized gas into a location other than the water vessel upon predetermined conditions. Ant, the water vessel may have a removable lid for adding water. The device may have at least one access lid, wherein the safety release valve is configured to prevent pressure from being released from the compressed gas container when the lid is removed. The coffee vessel may have a removable lid for adding coffee grounds, either separately or together with a lid over the water vessel.

Alternatively, hot water may be fed into the portable device also, possibly obviating the need for a water vessel or chamber, though both may be incorporated together in a portable device. In this sense, portable may mean relatively portable, where the device can be used to brew a beverage while being connected to a hot water source, such as a sink, an affixed water source such as a instant-hot tap found in many modern kitchens, or any other hot water source.

The water vessel and grounds vessel may be conjoined and have adjacent openings, the portable espresso maker further comprising a removable lid for giving access to the adjacent openings to add water and grounds. This device may include at least one access lid, wherein the safety release valve is configured to prevent pressure from being released from the compressed gas container when the lid is removed. A secondary port may be included in the valve that also serves as a vent for the water vessel when filled with boiling water to release the steam generated by the boiling water rather than pushing the water into the grounds vessel.

An access lid may cover over the water vessel, and a secondary port in the valve may also serve as a vent for the water vessel when filled with boiling water to release the steam generated by the boiling water rather than pushing the water into the grounds vessel. The secondary port may act as a vent to release excess pressure above a threshold at the end of the brewing process to allow for a safe opening of the access lid on top of the water vessel.

A safety valve may be included that prevents accidental release of compressed gas from the regulator towards the water vessel. The valve may allow compressed gas flow only when the lid is completely pressed down. This protects the user from getting injured if gas unexpectedly escapes.

The safety valve may be a one-way safety valve that prevents accidental release of compressed gas from the regulator towards the water vessel. The one-way safety valve may prevent accidental release of compressed gas from the regulator towards the water vessel, wherein the one-way valve is configured to allow compressed gas to flow only when the lid is completely closed to prevent the flow of gas outside the water vessel.

The a one-way safety valve may prevent accidental release of compressed gas from the regulator towards the water vessel.

The device may include a convenience light configured to illuminate an area about which brewed espresso will be poured.

The device may include at least one access lid, wherein the safety release valve is configured to prevent pressure from being released from the compressed gas container when the lid is removed. The device may alternatively include a first lid configured to cover grounds held within the mixing vessel and a second lid configured to cover water held within the water vessel. Or, it may include a dual seal lid configured to cover grounds held within the mixing vessel under one sealable covering and to cover water held within the water vessel under a second sealable covering.

The device may include a heat exchanger configured to warm up gas released from the compressed gas container to improve the flow of the released gas into the water vessel.

In another embodiment, a portable brewing device is provided that includes a compressed gas container, and also includes a pressure regulator coupled to the compressed gas container and configured to control the pressure of gas released from the compressed gas container. The device may also include a release switch communicating with pressure regulator and configured to release pressure controlled gas when actuated by a user, and a water vessel configured to receive the pressure controlled gas when the switch is actuated by a user. A mixing vessel is included having the ability to hold a brew substance communicating with the water vessel and configured to receive water from the water vessel to pass through the brew substance when pressure is released from the gas container through the pressure regulator. An outlet is configured to release a brewed product produced from water flowing through the brew substance contained in the mixing vessel when brewing.

The device may include a gas release mechanism configured to release the compressed gas from the compressed gas container under the control of the pressure regulator. The gas release mechanism may be configured to release compressed gas under the control of the pressure regulator. The gas release mechanism may be configured to access the compressed gas container, allowing the release switch to release compressed gas governed by the pressure regulator.

The compressed gas container may be a pre-compressed and sealed container, and wherein the release valve is a piercing member configured puncture the container to release compressed gas.

The pressure regulator may be a manual control configured to adjust pressure of gas released from the compressed gas container. The pressure regulator may be configured to control pressure within water vessel.

The pressure regulator may be configured to increase and decrease pressure within water vessel to cause the controlled transfer of water from the water vessel into the grounds vessel. The pressure regulator may be configured to control pressure within water vessel in a manner to transfer water from the water vessel into the grounds vessel in a controlled manner.

A water distributor may be included that is configured to distribute the water transferred into the grounds vessel in a controlled manner. The water distributor may be configured to distribute the water transferred into the grounds vessel in a controlled manner to evenly distribute the transferred water over a surface of grounds contained in the grounds vessel.

A safety release valve may be included, and configured to release pressurized gas into a location other than the water vessel upon predetermined conditions.

The water vessel may have a removable lid for adding water. There may be at least one access lid, wherein the safety release valve is configured to prevent pressure from being released from the compressed gas container when the lid is removed. There may be one removable lid for adding coffee grounds.

The water vessel and grounds vessel are conjoined and have adjacent openings, the portable espresso maker further comprising a removable lid for giving access to the adjacent openings to add water and grounds.

The device may include at least one access lid, wherein the safety release valve is configured to prevent pressure from being released from the compressed gas container when the lid is removed.

A convenience light may be configured to illuminate an area about which brewed espresso will be poured.

In one embodiment, a first lid may be configured to cover grounds held within the mixing vessel and a second lid configured to cover water held within the water vessel.

A dual seal lid may be configured to cover grounds held within the mixing vessel under one sealable covering and to cover water held within the water vessel under a second sealable covering.

A heat exchanger may be configured to warm up gas released from the compressed gas container to improve the flow of the released gas into the water vessel.

There may be an embodiment that provides one or more heating elements. The portable brewing device may include a compressed gas container; a pressure regulator coupled to the compressed gas container and configured to control the pressure of gas released from the compressed gas container; a release switch communicating with pressure regulator and configured to release pressure controlled gas when actuated by a user; a water vessel configured to receive the pressure controlled gas when the switch is actuated by a user; a heating element configured to increase the temperature of the water vessel; a mixing vessel having a brew substance, communicating with the water vessel and configured to receive water from the water vessel to pass through the brew substance when pressure is released from the gas container through the pressure regulator; and an outlet configured to release a brewed product produced from water flowing through the brew substance contained in the mixing vessel when brewing.

The heating element may be connected to a power source for heating the water in the water vessel. Or, the heating element includes a portable power source for heating the water in the water vessel. The heating element may also include a portable power source for heating the water in the water vessel.

Yet another embodiment may provide a portable espresso brewing device that has a compressed gas container; a pressure regulator coupled to the compressed gas container and configured to control the pressure of gas released from the compressed gas container; and a valve communicating with the pressure regulator that controls the flow of compressed gas into the water vessel. It may also include a secondary port in the valve that also serves as a vent for the water vessel when filled with boiling water to release the steam generated by the boiling water rather than pushing the water into the grounds vessel. This vent releases the excess pressure at the end of the brewing process to allow for a safe opening of the lid on top of the water vessel. It may further include a safety one way valve that prevents accidental release of compressed gas from the regulator towards the water vessel. The valve allows compressed gas flow only when the lid is completely pressed down, a water vessel communicating with the pressure regulator; a grounds vessel communicating with the water vessel and configured to receive water from the water vessel to brew espresso when pressure is released from the gas container through the pressure regulator; and an outlet configured to release espresso produced from water flowing through grounds contained in the grounds vessel when brewing.

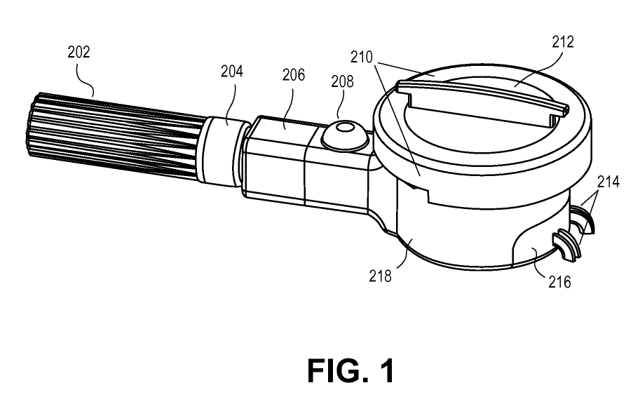

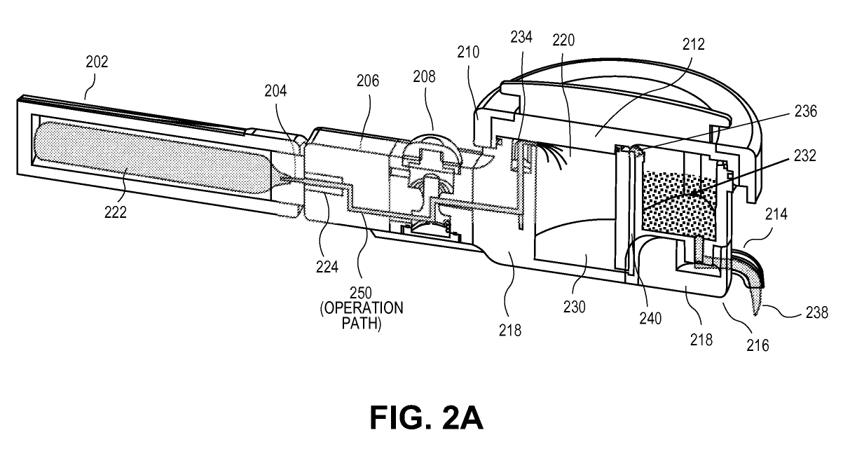

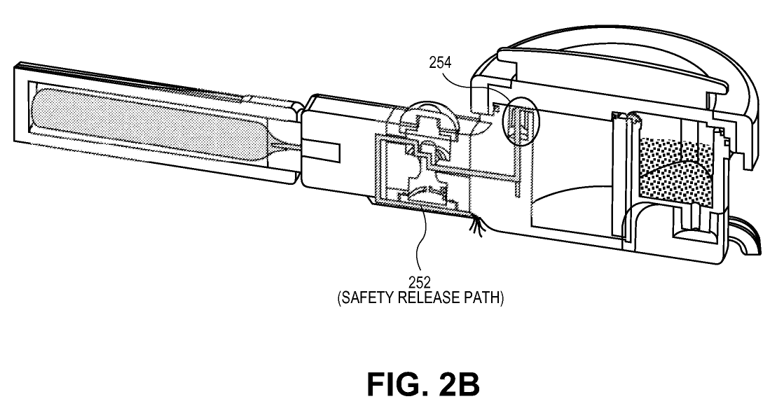

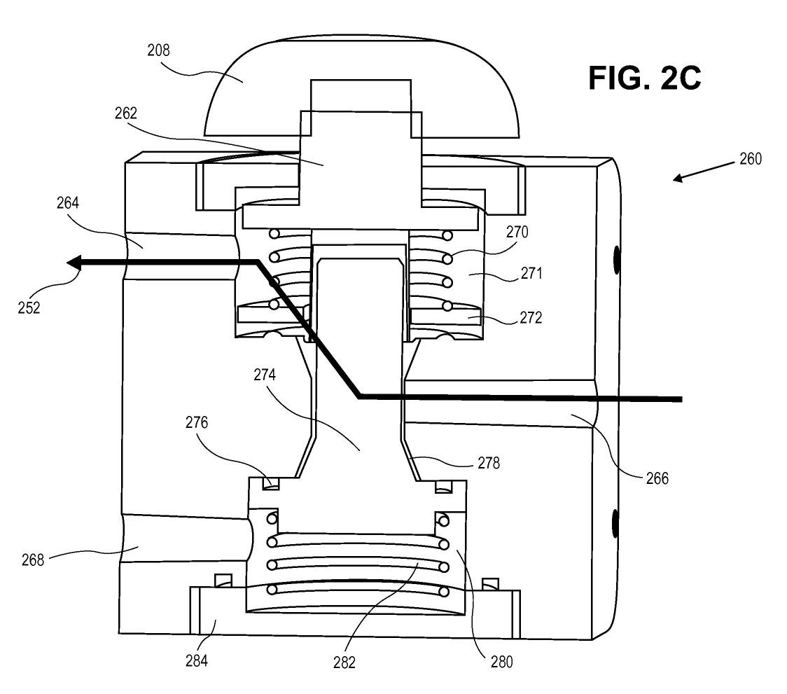

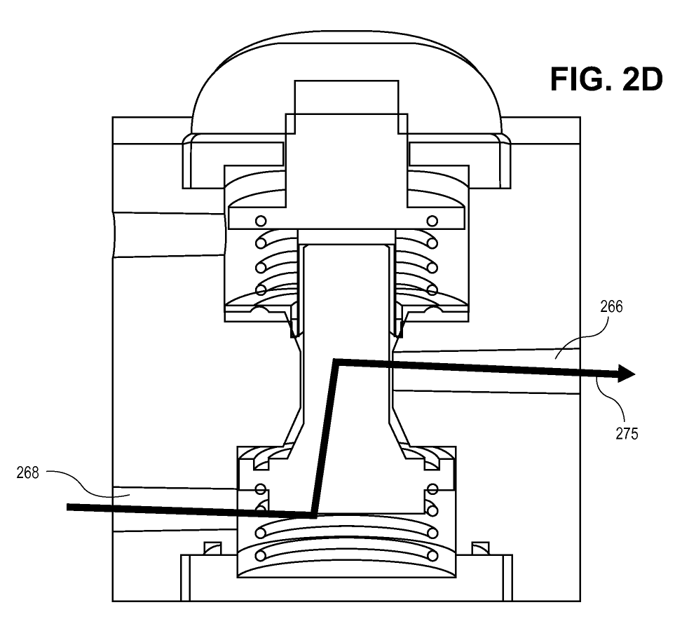

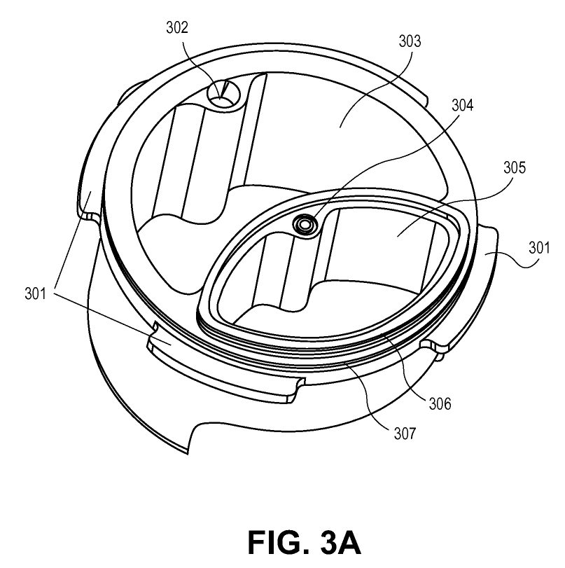

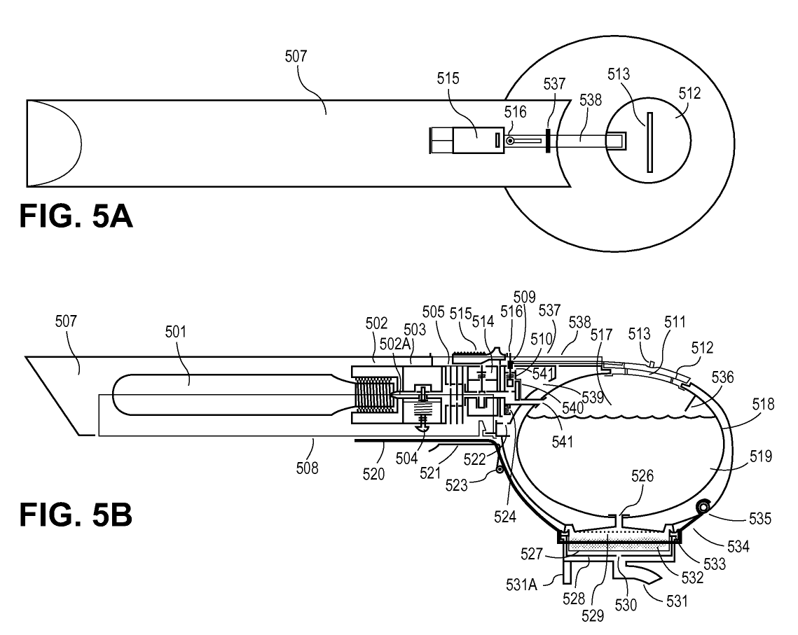

In the embodiment shown in FIG. 1 and the section view FIG. 2A it can be seen the device utilizes a compressed gas container (222) held in the device's handle (202), a piercing unit (204) (also 502 in FIG. 5B), a pressure regulator (206/224), a gas flow valve switch (208) comprised of two ports, a safety one way valve (234), a water vessel (230) for holding the hot water and a grounds vessel (232) for holding ground coffee or prepared coffee pods contained within the primary operating vessel (218), a water distributor (236), a pressure resistant lid (212) for enclosing the water vessel and grounds vessel (232), two separate seals to maintain a differential pressure between the water vessel and grounds vessel, locking bayonet ring (210) to seal the lid (212) against the primary operating vessel (218), a water transfer pipe (240), an outlet system (216), and two distribution spouts (214) (also 531 in FIG. 5B).

Referring to FIG. 2A, the operational directional path 250 is shown in the bold dark line from the compressed gas container through and into the water vessel 220.

FIG. 2B shows the reverse path, used in safety mode, where gas pressure from the water vessel resulting from hot water is released out the path 252 to a location outside the device. This occurs when excess pressure exists in the water vessel, and the switch is not pressed. Referring to FIG. 2C, the safety path is illustrated in more detail. The valve and switch assembly 260 may be assembled within the body of the device. When the switch button 208 is not pressed by a user, the path 252 is opened for gas to flow freely from the water vessel down path 252. A plunger or piston 262 is held up and away from the path and pressed with the pressure of a spring 270 or other resistant mechanism located within chamber 271. Plate 272 completes the chamber with O-rings to seal off the chamber 271 in operation, but is opened when in safety mode. The path allows gas to flow from path 266 to path 264, releasing gas pressure from the water chamber to a location outside the device. The chamber 280 is sealed off, closing off path 268, which is connected to the compressed gas container. This cuts off gas pressure when the device is not being engaged, the button 208 not pressed. The spring 282 holds the plunger or piston 274 to close against O-rings 276 to close off chamber 280, and path 268/278.

Referring to FIG. 2D, the operational flow path 250 is shown, where path 268 flows to path 266, which is the path from the compressed gas container to the water vessel, as illustrated in FIGS. 2A and 2B.

A device configured according to the invention has the advantage over existing devices due to its low weight, permitting it to be held and operated with a single-hand, its small size, making it highly portable and easily storable, and that it is made from very cost-effective components such as injection molded plastic, making it potentially more affordable than other espresso machines that meet similar operating pressures. In the embodiment shown in FIG. 1 the device can also be used without a source of electricity. The only external energy required is hot water and a cylinder containing compressed gas.

The compressed gas cylinder may be the disposable single-use type, or a compressed gas cylinder that may be recharged by many methods, some examples of which are an air pump that is built into the espresso maker or built into a stand into which the espresso maker can fit, or through the transfer of compressed gas from a secondary cylinder.

Where a disposable gas cylinder is used a method for piercing the cartridge is required. One example of such is the iSi-brand disposable gas cartridge and cream whip maker.

Furthermore, the horizontally linear arrangement of the water and grounds vessels in the embodiment shown prevents the continuous flow of water from the water vessel through the grounds vessel due to gravity or other siphon effects when the device isn't pressurized. However, the arrangement of the seals on the lid of the device in this embodiment creates a small positive pressure in the top of the water vessel as the lid is being closed causing the flow of a small amount of water through water pipe (240) into the grounds vessel. This provides a pre-infusion of the ground coffee allowing it to expand slightly and lock against the sides of the grounds vessel. This pre-infusion will typically last just a few seconds until the user is ready to make the espresso (238). Many commercial espresso machines also provide a pre-infusion because the expansion of the coffee ensures that once the water flow for the rest of the espresso commences it will quickly generate the correct back pressure against the water helping to ensure an ideal extraction. The safety one way valve (254) opens once the lid is completely sealed preventing build up of steam pressure in the water vessel which would push further water into the grounds vessel causing the undesired dripping of coffee before the valve switch is activated.

Another embodiment may use a more traditional vertical arrangement that places the water chamber before the espresso container, connected by a length of pipe.

In a further embodiment the espresso maker may have an electrical system for heating the water, and an additional output system and switch for controlling the flow of steam for the purpose of heating and frothing milk. The electrical power may be provided by a plurality of methods including a lead from a wall socket, by a stored electrical charge such as a battery, or by contact points from a base stand that has its own electrical supply. The electrical system may also provide additional features to the user such as indicator lights or a temperature readout to show when the water has been heated to the desired temperature for making espresso or for making steam.

The espresso maker shown in FIG. 1 is of the type that uses disposable single-use cartridges and does not include a recharger or electrical system.

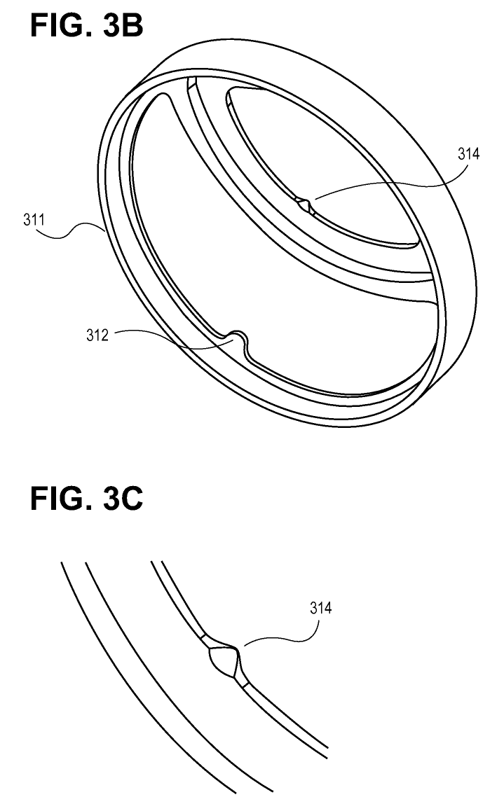

To produce espresso with the invention shown in FIG. 1 the user will fill the grounds vessel with ground coffee or a suitable coffee pod. The water vessel is filled with hot water and the lid is fitted down over the two sealing ridges that surround the water and coffee containers shown in FIG. 3A. The independent seals ensure there will be no transfer of air or water between the water and coffee containers except through water transfer pipe. The seals also permit the water vessel and grounds vessel to build and maintain the operating pressure of the device when the compressed gas is allowed into the top of the water vessel.

Referring to FIG. 3A, the locking bayonet ring is used to lock around the bayonet connectors (301) to force the lid down into the correct position and ensure that it is held firmly such that it will withstand the pressure generated within the device. The bayonets and the arrangement of the water vessel (303) seal ridge (307) and the grounds vessel (305) seal ridge (306) on the body of the device and the lid create a one way “key” pattern that ensures the lid can only be locked down when it is in a single precise orientation. In other embodiments different systems may be used to achieve the required seal for the water and grounds vessels. These include a screw-down lid or other type of restraint system. With the lid in place the safety one way valve ball (302) is depressed by a matching protrusion on the lid, opening the gas outlet channel.

A compressed gas container is placed in the device's handle. The handle is rotated such that the cartridge is screwed down on to the piercing member whereupon the gas flows through the gas inlet to the pressure regulator. The gas is stepped down to the target pressure and continues to the valve switch. The immediately preceding step may not be required in embodiments of this invention where a rechargeable cylinder or other supply of compressed gas is already connected to the gas inlet by some other means such as a length of pressure tube.

Disposable gas cartridges have an internal pressure of approximately 600 psi. The pressure regulator provides an output pressure that can be adjusted to produce the ideal pressure for making espresso of between 135-150 psi. In other embodiments this pressure may be user adjustable.

When the valve switch is activated gas is allowed to flow into the top of the water vessel past the safety one way valve. When the lid is not in position the safety one way valve ball is pushed against a holding spring so that it blocks the flow of gas.

Referring to FIG. 3B, when the lid (311) is in position the protrusion (312) pushes against the top of the safety one way valve ball (302) pushing it down into the gas outlet pipe and opening the pipe for the flow of gas.

As the gas flows into the top of the water vessel it pressurizes the air (shown as 517 in FIG. 5B) at the top of the chamber. This pressure pushes the water from the bottom of the water vessel through water transfer pipe (304) and into the top of the coffee vessel. The diameter of the water transfer pipe (304) ensures the water flows with sufficient velocity to hit the water dispersion unit (314) (shown in detail in FIG. 3C) that is built into the lid. The water dispersion unit sprays the water evenly over the surface of the coffee.

As the water continues to flow it rapidly fills the top of the coffee container and with the correctly ground coffee in place, will build up to the ideal operating pressure whereupon all the components of an espresso may be correctly extracted and generated. The espresso flows out the bottom of the coffee container, through the outlet manifold and into one or more beverage containers. The outlet manifold may be changed to cater for different outlet configurations including single or dual outlets.

When the valve is released the gas flow is stopped and any pressurized gas remaining in the water vessel is permitted to flow back through the secondary valve port in the switch where it can exit the device in a controlled manner. While gas can also escape through the coffee chamber and its outlets, □the switch's secondary exit method will quickly release pressure from the main chamber that will prevent further flow of coffee (or dribbles) into the cup. The rapid release of pressure also permits the lid to be opened in a safe manner almost immediately after production of the espresso has concluded.

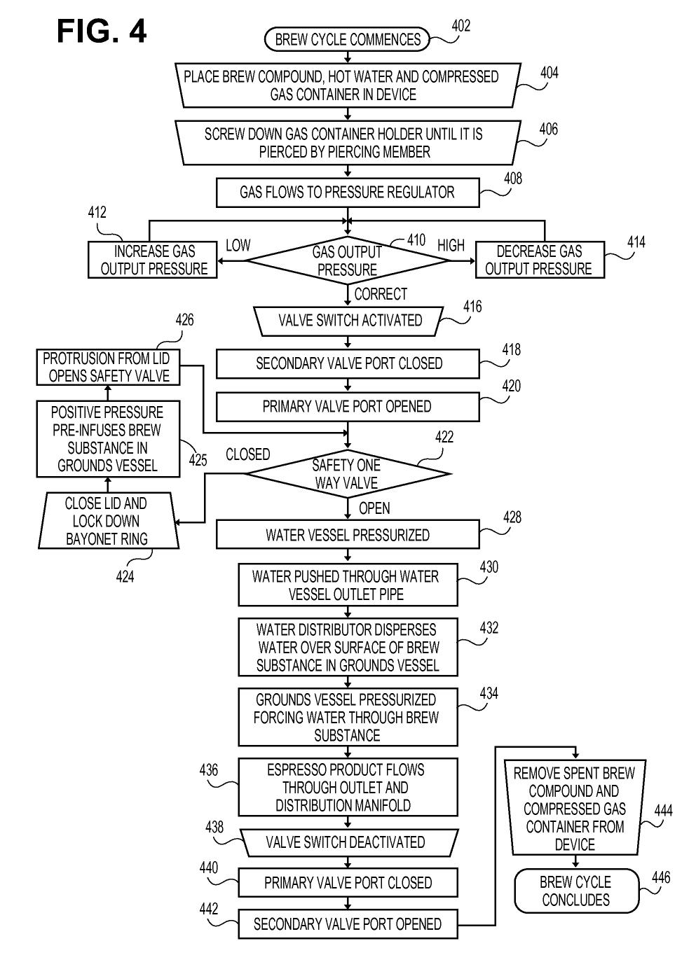

The flow of pressure in this invention can be seen in FIGS. 2A, 2B and in Process Flow Chart FIG. 4 where the gas flows from the compressed gas container through the pressure regulator. When the operator presses the valve switch the secondary valve port is closed and the primary valve port is opened, permitting the gas to flow towards the safety one way valve. If the lid is open the gas flow will be halted by the safety one way valve. When the lid is closed a protrusion in the lid opens the safety one way valve and permits the gas to flow in to the water vessel. The pressure of the gas pushes the water before it through the water transfer pipe where it is spread with the water dispersion device over the top of the coffee held in the grounds vessel. From there it will pass down through the ground coffee chamber and into the outlet system whereupon it exits the device via the distribution spouts. Releasing the valve switch closes the primary valve port and configures the gas channel through the switch so that any above atmospheric pressure within the sealed water and grounds vessels is released through the secondary valve port.

The flow of gas and the pressurization in this invention can be seen in FIG. 2A and in Process Flow Chart FIG. 4. Referring to FIG. 4, the brew cycle commences 402 with operator loading the device with brew compound, hot water and a compressed gas container 404. The handle is rotated so that it screws forward until the gas container is pierced 406. The gas flows from the compressed gas container to the pressure regulator 408. The pressure regulator adjusts the gas output pressure 410 by either increasing a too low pressure 412 or decreasing a too high pressure 414 until it reaches the correct pressure. The pressure regulator continues this process of adjustment the entire period the device is in operation. When the operator presses the valve switch 416 the secondary valve port is closed 418 to prevent gas from exiting via the safety vent, and the primary valve port is opened 420. The operation path of the gas in this configuration is shown in FIG. 2A. Referring back to FIG. 4, the gas flows towards the safety one way valve 422. If the lid is open the gas flow will be halted by the safety one way valve. While the lid is being closed and locked into position with the bayonet ring 424 a pre-infusion will take place 425. When the lid is fully closed a protrusion in the lid opens the safety one way valve 426 and permits the gas to flow in and pressurize the water vessel 428. The pressure of the gas pushes the water before it through the water transfer and outlet pipe 430 where it is spread with the water dispersion device over the top of the coffee held in the grounds vessel 432. From there it will pass down through the ground coffee or brew substance 434 and into the outlet system whereupon it exits the device via the distribution spouts 436. Releasing the valve switch 438 closes the primary valve port 440 preventing any more gas flow from the regulator and gas container, and opens the secondary valve port 442. This reconfigures the gas channel through the switch so that any above atmospheric pressure within the sealed water and grounds vessels is released through the secondary valve port 442. The operator removes any used brew compound or coffee grounds from the coffee vessel, and the used gas container from the device 444. This concludes the brew cycle 446.

Referring to FIGS. 5A-B, an alternative device and method is illustrated for delivering the required water pressure to the portafilter. By using compressed air (or Co2) (e.g., approx. 853 psi at 70° F.) that is either stored in a purchased cartridge 501 or recharged into an existing cartridge through an external pumping mechanism, the water 519 in the kettle 518 can be pressurized and forced through the coffee grounds 532 in the portafilter 534 resulting in the production of a coffee beverage that is pleasing to the consumer. The use of compressed air or gas obviates the need for an electrical pump, provides near silent operation, and can be designed to be held and be used with a single hand, as can be seen from the design shown in FIGS. 5A-B. A single small cartridge under normal use can produce approximately 40 espresso shots before requiring a change of cartridge or a recharge. Cartridge 501 may, for example, be held in a threaded cartridge holder 502, and encased beneath access cover 508 within handle 507, as shown in FIG. 5B.

To use the device the user must first fill the portafilter basket 527 with coffee or a coffee pod. This is achieved by releasing portafilter locking mechanism 521 (which may include hinge 523) and pulling down portafilter handle 520. The portafilter 534 pivots around hinge 535 with the end of the portafilter 534 able to slide out from behind the hinge 535. This enables the portafilter to be removed entirely from the device simplifying the replenishment of portafilter basket 527. The portafilter basket 527 may also be removed from the portafilter 534 for cleaning purposes, although in usual operation the entire portafilter assembly will simply be rinsed under a tap. The addition of the stand 531 a to the portafilter or the addition of a separate holding unit will give the portafilter and the entire unit stability when placed on a benchtop or other flat surface.

Once the user has finished replenishing the portafilter the ends of the portafilter are reinserted behind hinge 535 and the portafilter swung up into the locked position. This seals the portafilter basket 527 against the portafilter pressure seal 533. The user then uses his forefinger to force the portafilter locking mechanism 521 into the uppermost position, creating a high pressure force against the pressure seal 533 and ensuring the portafilter cannot swing into an unlocked position.

Immediately prior to using the device to produce espresso the user will remove external pressure cover 512 by rotating it anti-clockwise a quarter turn using pressure cover handle 513. If the external pressure cover 512 is locked in position by sliding lock 538, the user will first move sliding lock 538 back using sliding lock handle 537. A safety feature of this device is incorporated into safety pressure lock 509. Where there is substantial internal pressure in the kettle, pressure will be transmitted to the piston attached to pressure lock 509. This will force the piston up, compressing return spring 510 and pushing the pressure lock pin in an upwards direction, blocking the path of sliding lock 538 and thus preventing the user from rotating the external pressure cover. To release the internal pressure the user can force down the manual release button 516. This will cause pressure to vent through manual pressure release pipe 540 into the now exposed internal piston area of the pressure safety lock, out through vent 541 and vent 539, into the internal cavity surrounding the kettle where excess pressure, fluid or vapor may escape through vents 522 provided in the bottom of the device near the portafilter, away from the user's hand. Where there is low or no internal pressure the return spring 510 will keep the safety lock 509 in the retracted position, enabling sliding lock 538 to be moved back into the handle and the pressure cover rotated and removed.

Turning the external pressure cover will also turn the internal pressure cover 511, which is firmly attached to the external pressure cover, resulting in the unsealing of the kettle and the easy removal of the pressure covers.

The user fills the internal kettle 518 with boiling water up to the level indicated by indicator 536 and replaces external pressure cover 512. The water temperature will reduce slightly to the ideal temperature range of 197° F.-205° F. over the few seconds it takes to close the external pressure cover 512 and to position the device over the output vessel. The user then manipulates thumb switch 515. Sliding lock 538 will prevent thumb switch 515 from moving forward if the lock has not been moved into its full forward position over the external pressure cover. The lock cannot be moved forward where the pressure cover has not been rotated so that the gap in the upper surface of the pressure cover aligns with the channel through which the sliding lock will move. This safety feature prevents a situation where the user may place the external pressure cover 512 on the vessel but not rotate it into its locked position.

On sliding forward thumb switch 515 the gas release piston 514 is moved down enabling gas to flow through a hole drilled in the center of the piston. To ensure an even supply of pressure to the kettle an adjustable gas regulator 503 (e.g., input pressure 600-1200 psi, output pressure 90-150 psi) is included immediately after the gas canister. The user may adjust the gas pressure produced on the outlet side of the regulator using adjustment screw 504 (or component 284 shown in FIG. 2C). The gas regulator is a common component already well known.

The temperature of gas reduces sharply as it changes from a compressed to an uncompressed form. This is one of the principles of refrigeration. It would be deleterious to bring refrigerated gas into contact with the water in the kettle as this may cause the temperature of the kettle water to drop below its ideal brewing extraction temperature. Thermocouple 505 (also shown as 224 in FIG. 2A) acts as an expansion and warming chamber for the gas by providing a varied path through which the gas must travel to the exit side of the chamber, bringing it into multiple contacts with highly heat conductive copper discs contained in the thermocouple unit. The discs act as a heat exchange between the internal chamber and the external area inside the device handle 507. In an alternative embodiment the gas may instead leave thermocouple 505 and run through a single pipe that makes its way around the inside of handle 507 and connect back to gas release piston 514. This will bring the gas into contact with higher temperature surfaces. These surfaces in turn will receive a helpful temperature boost from the heat transferred from the hand of the user as they hold the device.

The gas flows through the exit outlet of piston 514, past the overpressure safety valve outlet 524. Overpressure safety valve outlet 524 is a common component characterized as a ball bearing held against and thus sealing an outlet with the aid of a spring. When the internal pressure exceeds the pressure provided by the ball and spring the ball is pushed into its cylinder allowing gas to escape past the ball and through a vent provided in the spring housing area. In this design the gas will vent into the cavity surround the kettle, being directed downwards and away from the user.

The gas from the cartridge will then continue past the underside of the piston attached to pressure release button 516, past the small pressure pipe 540 that leads back to the manual pressure release piston, and ultimately into the kettle via vent 541.

The pressure in the kettle will be built up until it reaches the pressure permitted by the gas regulator, pushing the water in the kettle down through outlet port 526. The water will spread over water distribution grid 529. The distribution grid is a disc through which numerous small holes have been punched. The grid encourages the even distribution of the water onto the surface of the portafilter basket causing the remaining water to take multiple paths through the coffee rather than just the one path of least resistance. This exposes more of the coffee grounds to the water, encouraging a more complete extraction of the essential oils and other compounds from the coffee, leading to a better base extraction and crema.

Once sufficient water has flown through the device the user will remove their thumb from sliding switch 515 allowing it to retract back towards the handle. This will permit the gas release piston to move in an upwards direction motivated by its return spring, shutting off the flow of gas from the canister.

An embodiment of the device may also include a portafilter backpressure layer 528 and portafilter backpressure water outlet 530, as shown in FIG. 5B.

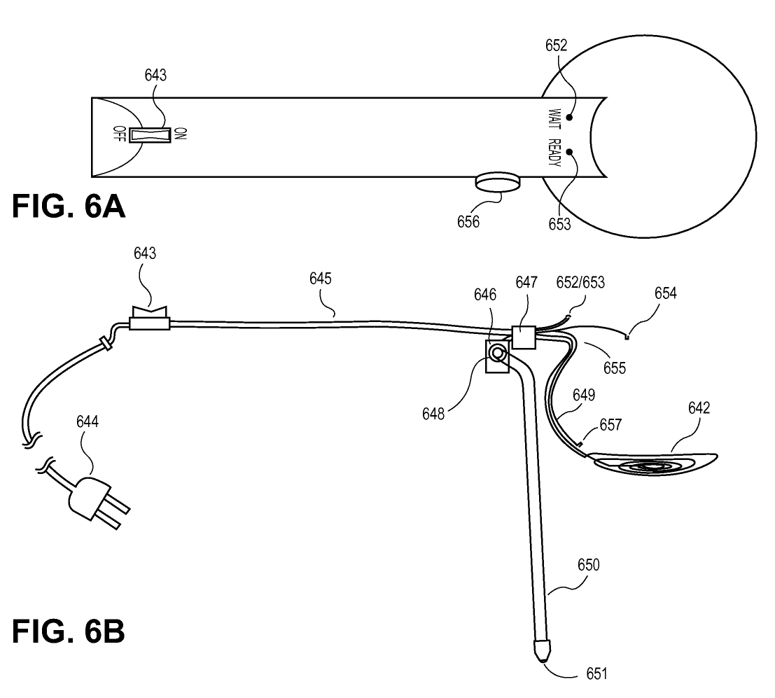

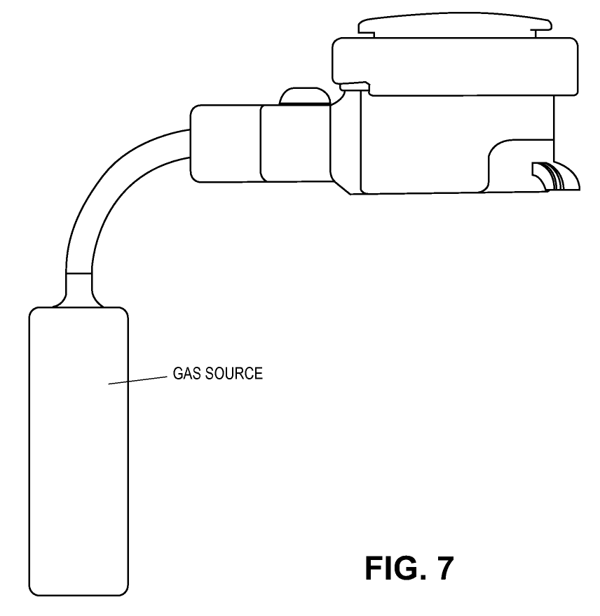

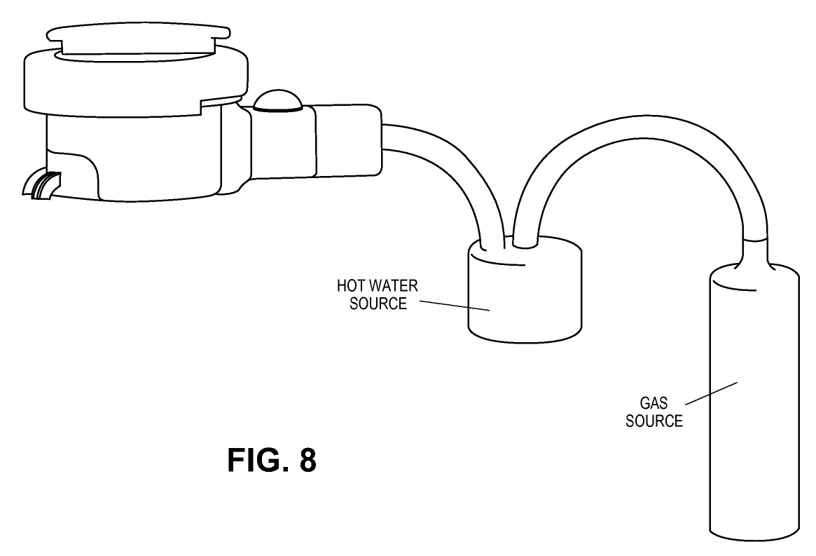

If the user desires a frothy milk accompaniment to their espresso (such as for a latte or cappuccino), they may use an external source to heat the milk and any of numerous frothing devices already available on the market to prepare the milk for inclusion in the beverage, or they may use an embodiment of the device shown in FIGS. 6A-B to prepare the milk.

The alternate embodiment of the invention shown in FIG. 6A-B uses an electrical source and a control unit to power a heater element 642 built into the bottom of kettle 518. The heater element 642 is operated automatically by the control unit and will heat the water to two possible temperatures: the ideal temperature for producing espresso, or a higher temperature suitable for producing steam. An indicator light will show when the unit is ready for operation in either mode. The user will then either operate the thumb switch to produce espresso as described earlier in this invention, or operate a steam wand 650 (which may include steam outlet adaptor 651) to heat and froth the milk.

FIG. 6B shows an example design using a standard plug 644 as the electrical source. The power is controlled with the On/Off switch 643. Power flows through wires 645/649 to/from power control unit 647. The control unit receives temperature inputs from steam sensor 654 and/or water temperature sensor 657. The steam wand swivel 648 provides position information to the power control unit. When the steam wand is in the closed position (tucked inside the a slot in the bottom of the device's handle) the power control unit will turn on the water heater element 642 and show the “Wait” indicator light 652 until the water temperature sensor provides data to the control unit that the water has been brought up to the appropriate temperature for producing the beverage. At this time the control unit will turn off the water heater element 642 and display the “Ready” indicator light 653. If the temperature falls back to a predetermined level it will once again power the water heater element 642, turn off the Ready light and display the Wait light until the temperature is brought up to the correct level.

The pressurized source into the main kettle has been adapted to include U-Bend 655 which protects against water inadvertently flowing back down the inlet pressure tube and out the steam wand. Other protection system such as a backflow valve may also be used. The flow of steam out the steam wand is controlled using rotating knob 656 which connects to a steam control valve that may be internal or external to the steam control manifold 646.

When the steam wand is in the open or “down” position shown in FIG. 6B, the power control unit will use temperature data from the steam sensor, turning on the water heater element 642 until an appropriate temperature for the steam in the cavity above the water has been reached. When the appropriate temperature is reached the unit will leave the water heater element 642 on but will display the “Ready” indicator light. A constant supply of heat to the water is required to keep a ready supply of steam being constantly generated as the steam unit is used.

The unit will use the water temperature sensor to ensure the unit cannot reach a dangerous operating temperature, shutting off the heater element 642 if this temperature is reached. Where the heater element 642 has been shut off due to an over temperature condition the heater element 642 will not be switched back on until the entire unit has been switched off and on again. The Wait indicator light 652 and the Ready indicator light 653 will flash together in a repeating cycle when an over temperature condition has been reached alerting the user to a fault condition.

This invention in all its embodiments is not limited to utilizing electrical power from a mains power source. With the addition of an appropriate battery to the design it can also use a stored source of power, or a rechargeable source of power. A special holder stand with integrated electrical power may also be used to supply power to the unit.

This invention can also produce beverages other than just espresso. By adapting the portafilter to hold coffee pods, the portafilter may also use other types of pods that provide compounds for beverages such as hot chocolate, tea, flavored coffees, and any other type of beverage so designed.

FIGS. 7 and 8 illustrate commercial embodiments of devices configured according to the invention. FIG. 7 shows a version where the gas source is separate from the device. FIG. 8 illustrates a configuration where the gas source communicates with the hot water source, and where the water source communicates with the device. Essentially, these embodiments show that different components can be extended to larger components outside the device, then connected in with supply lines. This allows for high volume use.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A portable espresso brewing device, comprising:
a compressed gas container;
a pressure regulator coupled to the compressed gas container and configured to control the pressure of gas released from the compressed gas container;
a valve communicating with the pressure regulator that controls the flow of compressed gas into the water vessel.
a water vessel communicating with the pressure regulator;
a grounds vessel communicating with the water vessel and configured to receive water from the water vessel to brew espresso when pressure is released from the gas container through the pressure regulator; and
an outlet configured to release espresso produced from water flowing through grounds contained in the grounds vessel when brewing.

2. A portable espresso brewing device according to claim 1, further comprising a piercing member configured to puncture the compressed gas container to release the compressed gas under the control of the pressure regulators.

3. A portable espresso brewing device according to claim 1, further comprising a release valve configured to puncture the compressed gas container to release the compressed gas under the control off the pressure regulator.

4. A portable espresso maker according to claim 3, wherein the compressed gas container is a pre-compressed and sealed container, and wherein the release valve is a piercing member configured to puncture the container to release compressed gas.

5. A portable espresso maker according to claim 1, wherein the pressure regulator is a manual control configured to adjust pressure of gas released from the compressed gas container.

6. A portable espresso brewing device according to claim 1, further comprising a release valve configured to expose the compressed gas to the pressure regulator to enable controlled release—the valve is not between the compressed gas source and the regulator but between the regulator and the water vessel

7. A portable espresso maker according to claim 1, wherein the pressure regulator is configured to control pressure within water vessel.

8. A portable espresso maker according to claim 1, wherein the pressure regulator is configured to control pressure released from the compressed gas container.

9. A portable espresso maker according to claim 7, wherein the pressure regulator is configured to increase and decrease pressure within the water vessel to cause the controlled transfer of water from the water vessel into the grounds vessel.

10. A portable espresso maker according tog claim 1, wherein the pressure regulator is configured to control pressure within water vessel in a manner to transfer water from the water vessel into the grounds vessel in a controlled manner.

11. A portable espresso maker according to claim 10, further comprising a water distributor configured to distribute the water transferred into the grounds vessel in a controlled manner.

12. A portable espresso maker according to claim 10, further comprising a water distributor configured to distribute the water transferred into the grounds vessel in a controlled manner to evenly distribute the transferred water over a surface of grounds contained in the grounds vessel.

13. A portable espresso maker according to claim 1, further comprising a safety release valve configured to release pressurized gas into a location other than the water vessel upon predetermined conditions.

14. A portable espresso maker according to claim 1, wherein the water vessel has a removable lid for adding water.

15. A portable espresso maker according to claim 1, further comprising at least one access lid, wherein the safety release valve is configured to prevent pressure from being released from the compressed gas container when the lid is removed.

16. A portable espresso maker according to claim 1, wherein the coffee vessel has a removable lid for adding coffee grounds.

17. A portable espresso maker according to claim 1, wherein the water vessel and grounds vessel are conjoined and have adjacent openings, the portable espresso maker further comprising a removable lid for giving access to the adjacent openings to add water and grounds.

18. A portable espresso maker according to claim 13, further comprising at least one access lid, wherein the safety release valve is configured to prevent pressure from being released from the compressed gas container when the lid is removed.

19. A portable espresso maker according to claim 1, further comprising a secondary port in the valve also serves as a vent for the water vessel when filled with boiling water to release the steam generated by the boiling water rather than pushing the water into the grounds vessel.

20. A portable espresso maker according to claim 1, further comprising an access lid that covers over the water vessel, and a secondary port in the valve also serves as a vent for the water vessel when filled with boiling water to release the steam generated by the boiling water rather than pushing the water into the grounds vessel.

21. A portable espresso maker according to claim 20, wherein the secondary port acts as a vent to release excess pressure above a threshold at the end of the brewing process to allow for a safe opening of the access lid on top of the water vessel.

22. A portable espresso maker according to claim 19, further comprising a safety valve that prevents accidental release of compressed gas from the regulator towards the water vessel. The valve allows compressed gas flow only when the lid is completely pressed down.

23. A portable espresso maker according to claim 19, further comprising a one-way safety valve that prevents accidental release of compressed gas from the regulator towards the water vessel.

24. A portable espresso maker according to claim 19, further comprising a one-way safety valve that prevents accidental release of compressed gas from the regulator towards the water vessel, wherein the one-way valve is configured to allow compressed gas to flow only when the lid is completely closed to prevent the flow of gas outside the water vessel.

25. A portable espresso maker according to claim 19, further comprising a one-way safety valve that prevents accidental release of compressed gas from the regulator towards the water vessel.

26. A portable espresso maker according to claim 1, further comprising a convenience light configured to illuminate an area about which brewed espresso will be poured.

27. A portable brewing device according to claim 17, further comprising at least one access lid, wherein the safety release valve is configured to prevent pressure from being released from the compressed gas container when the lid is removed.

28. A portable espresso maker according to claim 1, further comprising a convenience light configured to illuminate an area about which brewed espresso will be poured.

29. A portable espresso maker according to claim 1, further comprising a first lid configured to cover grounds held within the mixing vessel and a second lid configured to cover water held within the water vessels.

30. A portable espresso maker according to claim 1, further comprising a dual seal lid configured to cover grounds held within the mixing vessel under one sealable covering and to cover water held within the water vessel under a second sealable covering.

31. A portable espresso maker according to claim 1, further comprising a heat exchanger configured to warm up gas released from the compressed gas container to improve the flow of the released gas into the water vessel.

32. A portable brewing device, comprising:
a compressed gas container;
a pressure regulator coupled to the compressed gas container and configured to control the pressure of gas released from the compressed gas container;
a release switch communicating with pressure regulator and configured to release pressure controlled gas when actuated by a user;
a water vessel configured to receive the pressure controlled gas when the switch is actuated by a user;
a mixing vessel having a brew substance communicating with the water vessel and configured to receive water from the water vessel to pass through the brew substance when pressure is released from the gas container through the pressure regulator; and
an outlet configured to release a brewed product produced from water flowing through the brew substance contained in the mixing vessel when brewing.

33. A portable brewing device according to claim 32, further comprising a gas release mechanism configured to releaser the compressed gas from the compressed gas container under the control of the pressure regulator.

34. A portable brewing device according to claim 33, wherein the gas release mechanism is configured to release compressed gas under the control of the pressure regulator.

35. A portable brewing device according to claim 33, wherein gas release mechanism is configured to access the compressed gas container, allowing the release switch to release compressed gas governed by the pressure regulator.

36. A portable brewing device according to claim 33, wherein the compressed gas container is a pre-compressed and sealed container, and wherein the release valve is a piercing member configured puncture the container to release compressed gas.

37. A portable brewing device according to claim 32, wherein the pressure regulator is a manual control configured to adjust pressure of gas released from the compressed gas container.

38. A portable brewing device according to claim 32, wherein the pressure regulator is configured to control pressure within water vessel.

39. A portable brewing device according to claim 32, wherein the pressure regulator is configured to increase and decrease pressure within water vessel to cause the controlled transfer of water from the water vessel into the grounds vessel.

40. A portable brewing device according to claim 32, wherein the pressure regulator is configured to control pressure within water vessel in a manner to transfer water from the water vessel into the grounds vessel in a controlled manner.

41. A portable brewing device according to claim 40, further comprising a water distributor configured to distribute the water transferred into the grounds vessel in a controlled manner.

42. A portable brewing device according to claim 40, further comprising a water distributor configured to distribute the water into the grounds vessel in a controlled manner to evenly distribute the transferred water over a surface of grounds contained in the grounds vessel.

43. A portable brewing device according to claim 32, further comprising a safety release valve configured to release pressurized gas into a location other than the water vessel upon predetermined conditions.

44. A portable brewing device according to claim 32A wherein the water vessel has a removable lid for adding water.

45. A portable brewing device according to claim 44, further comprising at least one access lid, wherein the safety release valve is configured to prevent pressure from being released from the compressed gas container when the lid is removed.

46. A portable brewing device according to claim 32, wherein the coffee vessel has a removable lid for adding coffee grounds.

47. A portable brewing device according to claim 32, wherein the water vessel and grounds vessel are conjoined and have adjacent openings, the portable espresso maker further comprising a removable lid for giving access to the adjacent openings to add water and grounds.

48. A portable brewing device according to claim 42, further comprising at least one access lid, wherein the safety release valve is configured to prevent pressure from being released from the compressed gas container when the lid is removed.

49. A portable espresso maker according to claim 32, further comprising a convenience light configured to illuminate an area about which brewed espresso will be poured.

50. A portable espresso maker according to claim 32, further comprising a first lid configured to cover grounds held within the mixing vessel and a second lid configured to cover water held within water vessel.

51. A portable espresso maker according to claim 32, further comprising a dual seal lid configured to cover grounds held within the mixing vessel under one sealable covering and to cover water held within the water vessel under a second sealable covering.

52. A portable espresso maker according to claim 32, further comprising a heat exchanger configured to warm up gas released from the compressed gas container to improve the flow of the released gas into the water vessel.

53. A portable espresso brewing device, comprising:
a compressed gas container;
a pressure regulator coupled to the compressed gas container and configured to control the pressure of gas released from the compressed gas container;
a valve communicating with the pressure regulator that controls the flow of compressed gas into the water vessel.
a secondary port in the valve that also serves as a vent for the water vessel when filled with boiling water to release the steam generated by the boiling water rather than pushing the water into the grounds vessel. This vent releases the excess pressure at the end of the brewing process to allow for a safe opening of the lid on top of the water vessel.
a safety one way valve that prevents accidental release of compressed gas from the regulator towards the water vessel. The valve allows compressed gas flow only when the lid is completely pressed down.
a water vessel communicating with the pressure regulator;
a grounds vessel communicating with the water vessel and configured to receive water from the water vessel to brew espresso when pressure is released from the gas container through the pressure regulator; and
an outlet configured to release espresso produced form water flowing through grounds contained in the grounds vessel when brewing.

54. A portable espresso maker according to claim 53, wherein the heating element can be connected to a power source for heating the water in the water vessel.

55. A portable espresso maker according to claim 53, wherein the heating element includes a portable power source for heating the water in the water vessel.

56. A portable espresso maker according to claim 53, wherein the heating element includes a portable power source for heating the water in the water vessel.

57. A portable espresso brewing device, comprising:
a compressed gas container;
a pressure regulator coupled to the compressed gas container and configured to control the pressure of gas released from the compressed gas container;
a valve communicating with the pressure regulator that controls the flow of compressed gas into the water vessel.
a secondary port in the valve that also serves as a vent for the water vessel when filled with boiling water to release the steam generated by the boiling water rather than pushing the water into the grounds vessel, where the secondary port releases the excess pressure at the end of the brewing process to allow for a safe opening of the lid on top of the water vessel;
a safety one way valve that prevents accidental release of compressed gas from the regulator towards the water vessel, where the valve allows compressed gas flow only when the lid is completely pressed down;
a water vessel configured to hold water and communicating with the pressure regulator;
a grounds vessel configured to hold espresso grounds, communicating with the water vessel and configured to receive water from the water vessel to brew espresso when pressure is released from the gas container through the pressure regulator, transferring water from the water vessel and through the grounds; and
an outlet configured to release espresso produced from water flowing through grounds contained in the grounds vessel when brewing.
